(19) United States
(12) Patent Application Publication
(10) Pub. No.: US 2024/0314648 A1
(43) Pub. Date: Sep. 19, 2024

(54) HANDOVER OPTIMIZATION FOR HIGH MOBILITY COMMUNICATIONS

(71) Applicant: QUALCOMM Incorporated, San Diego, CA (US)

(72) Inventors: Zhanyi LIU, Beijing (CN); Yongle WU, San Diego, CA (US); Rashmi Ranjan MOHANTY, San Diego, CA (US); Jing LI, Shanghai (CN); Rajarajan RAJENDRAN, San Diego, CA (US); Jie MAO, Beijing (CN); Ashok MANTRAVADI, San Diego, CA (US); Jie ZHU, Beijing (CN); Nanrun WU, Beijing (CN)

(21) Appl. No.: 18/571,145

(22) PCT Filed: Aug. 20, 2021
(86) PCT No.: PCT/CN2021/113755

§ 371 Date: Dec. 15, 2023

(51) Int. Cl. H04W 36/00; H04W 36/30

(52) U.S. Cl. CPC H04W 36/0058; H04W 36/302; H04W 36/304

(57) ABSTRACT

Methods, systems, and devices for wireless communications at a user equipment (UE) are described. The UE may identify that the UE is operating in a high mobility environment, that a first reference signal received power associated with a first cell is decreasing, and that a second reference signal received power associated with a second cell is increasing. The UE may transmit a request for a handover from the first cell to the second cell based on the identifying, the transmitting performed at a time that may be based on one or more network-configured handover timing parameters having one or more values adjusted by the UE. The UE may receive a handover command in response to transmitting the request for handover. The UE may perform a handover from the first cell to the second cell in response to the handover command.

### CROSS REFERENCE

The present Application is a 371 national stage filing of International PCT Application No. PCT/CN2021/113755 by LIU et al. entitled “HANDOVER OPTIMIZATION FOR HIGH MOBILITY COMMUNICATIONS,” filed Aug. 20, 2021, which is assigned to the assignee hereof, and which is expressly incorporated by reference in its entirety herein.

### FIELD OF TECHNOLOGY

The following relates to wireless communications at a user equipment (UE), including handover optimization for high mobility communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications system, a wireless device may move between various cells while communicating. The wireless device may implement a handover procedure to switch between cells. Some methods for such power-splitting schemes may be deficient.

### SUMMARY

The described techniques relate to improved methods, systems, devices, and apparatuses that support handover optimization for high mobility communications. A user equipment (UE) may identify that the UE is operating in a high mobility environment. Additionally or alternatively, the UE may identify that a first reference signal received power associated with a first cell is decreasing, and that a second reference signal received power associated with a second cell is increasing. The UE may adjust one or more network-configured handover timing parameters based on being in the high mobility environment, and the UE may transmit a request for a handover from the first cell to the second cell at a time based on the one or more network-configured handover timing parameters having the one or more UE-adjusted values (e.g., as opposed to having the network-configured values). The UE may receive a handover command in response to transmitting the request for handover. The UE may perform a handover from the first cell to the second cell in response to the handover command.

A method for wireless communications at a UE is described. The method may include identifying that the UE is operating in a high mobility environment, that a first reference signal received power associated with a first cell is decreasing, and that a second reference signal received power associated with a second cell is increasing, transmitting a request for a handover from the first cell to the second cell based on the identifying, the transmitting performed at a time that is based on one or more network-configured handover timing parameters having one or more values adjusted by the UE, receiving a handover command in response to transmitting the request for handover, and performing a handover from the first cell to the second cell in response to the handover command.

An apparatus for wireless communications at a UE is described. The apparatus may include a processor, memory coupled with the processor, and instructions stored in the memory. The instructions may be executable by the processor to cause the apparatus to identify that the UE is operating in a high mobility environment, that a first reference signal received power associated with a first cell is decreasing, and that a second reference signal received power associated with a second cell is increasing, transmit a request for a handover from the first cell to the second cell based on the identifying, the transmitting performed at a time that is based on one or more network-configured handover timing parameters having one or more values adjusted by the UE, receive a handover command in response to transmitting the request for handover, and perform a handover from the first cell to the second cell in response to the handover command.

Another apparatus for wireless communications at a UE is described. The apparatus may include means for identifying that the UE is operating in a high mobility environment, that a first reference signal received power associated with a first cell is decreasing, and that a second reference signal received power associated with a second cell is increasing, means for transmitting a request for a handover from the first cell to the second cell based on the identifying, the transmitting performed at a time that is based on one or more network-configured handover timing parameters having one or more values adjusted by the UE, means for receiving a handover command in response to transmitting the request for handover, and means for performing a handover from the first cell to the second cell in response to the handover command.

A non-transitory computer-readable medium storing code for wireless communications at a UE is described. The code may include instructions executable by a processor to identify that the UE is operating in a high mobility environment, that a first reference signal received power associated with a first cell is decreasing, and that a second reference signal received power associated with a second cell is increasing, transmit a request for a handover from the first cell to the second cell based on the identifying, the transmitting performed at a time that is based on one or more network-configured handover timing parameters having one or more values adjusted by the UE, receive a handover command in response to transmitting the request for handover, and perform a handover from the first cell to the second cell in response to the handover command.

Some examples of the method, apparatuses, and non-transitory computer-readable medium described herein may further include operations, features, means, or instructions for adjusting a value of a first network-configured handover timing parameter of the one or more network-configured handover timing parameters, where the first network-configured handover timing parameter corresponds to a delay between a first time at which a difference between the second reference signal received power and the first reference signal received power satisfies a threshold and a second time at which the request for handover may be transmitted, and where the time at which the UE transmits the request for handover may be based on the adjusted value of the first network-configured handover timing parameter.

In some examples of the method, apparatuses, and non-transitory computer-readable medium described herein, the adjusted value of the first network-configured handover timing parameter may be zero.

Some examples of the method, apparatuses, and non-transitory computer-readable medium described herein may further include operations, features, means, or instructions for adjusting a value of a second network-configured handover timing parameter of the one or more network-configured handover timing parameters, where the second network-configured handover timing parameter corresponds to a threshold difference between the second reference signal received power and the first reference signal received power, and where the time at which the UE transmits the request for handover may be based on a difference between the second reference signal received power and the first reference signal received power satisfying the adjusted value of the second network-configured handover timing parameter.

In some examples of the method, apparatuses, and non-transitory computer-readable medium described herein, the adjusted value of the second network-configured handover timing parameter may be zero.

Some examples of the method, apparatuses, and non-transitory computer-readable medium described herein may further include operations, features, means, or instructions for adjusting a value of a third network-configured handover timing parameter of the one or more network-configured handover timing parameters after performing the handover, where the adjusted value of the third network-configured handover timing parameter decreases a likelihood of the UE initiating a second handover from the second cell to the first cell.

In some examples of the method, apparatuses, and non-transitory computer-readable medium described, transmitting the request for the handover may be based on the first reference signal received power becoming less than or equal to the second reference signal received power.

In some examples of the method, apparatuses, and non-transitory computer-readable medium described herein, operations, features, means, or instructions for transmitting the request for the handover may include operations, features, means, or instructions for transmitting a measurement report based on the first reference signal received power associated with the first cell, the second reference signal received power associated with the second cell, or any combination thereof.

Some examples of the method, apparatuses, and non-transitory computer-readable medium described herein may further include operations, features, means, or instructions for identifying a sequence of cells associated with a mobility path of the UE, where transmitting the request for the handover from the first cell to the second cell may be based on the second cell being subsequent to the first cell within the sequence of cells.

In some examples of the method, apparatuses, and non-transitory computer-readable medium described herein, operations, features, means, or instructions for receiving the handover command may include operations, features, means, or instructions for receiving downlink control information that includes the handover command.

Some examples of the method, apparatuses, and non-transitory computer-readable medium described herein may further include operations, features, means, or instructions for storing, at the UE, an indication of the high mobility environment based on identifying that the UE may be operating in the high mobility environment.

In some examples of the method, apparatuses, and non-transitory computer-readable medium described herein, the high mobility environment may be associated with a high-speed train.

In some examples of the method, apparatuses, and non-transitory computer-readable medium described herein, the high mobility environment may be associated with a motor vehicle.

Some examples of the method, apparatuses, and non-transitory computer-readable medium described herein may further include operations, features, means, or instructions for receiving one or more first values of the one or more network-configured handover timing parameters from a network entity and setting, after receiving the one or more first values, the one or more network-configured handover timing parameters to may have one or more second values, where the one or more network-configured handover timing parameters may have the one or more values adjusted by the UE based on the UE setting the one or more network-configured handover timing parameters to may have the one or more second values.

### BRIEF DESCRIPTION OF THE DRAWINGS

FIG. 1 illustrates an example of a wireless communications system that supports handover optimization for high mobility communications in accordance with aspects of the present disclosure.

FIG. 2 illustrates an example of a system that supports handover optimization for high mobility communications in accordance with aspects of the present disclosure.

FIG. 3 illustrates an example of a handover scenario that supports handover optimization for high mobility communications in accordance with aspects of the present disclosure.

FIG. 4 illustrates an example of a process flow that supports handover optimization for high mobility communications in accordance with aspects of the present disclosure.

FIGS. 5 and 6 show block diagrams of devices that support handover optimization for high mobility communications in accordance with aspects of the present disclosure.

FIG. 7 shows a block diagram of a communications manager that supports handover optimization for high mobility communications in accordance with aspects of the present disclosure.

FIG. 8 shows a diagram of a system including a device that supports handover optimization for high mobility communications in accordance with aspects of the present disclosure.

FIGS. 9 through 12 show flowcharts illustrating methods that support handover optimization for high mobility communications in accordance with aspects of the present disclosure.

### DETAILED DESCRIPTION

In the course of operation, some wireless devices may from time to time be used in a high-mobility scenario (e.g., a scenario in which the UE may be travelling in a vehicle at high speeds, such as a motor vehicle or a high speed train). However, in such environments, conventional techniques often result in radio link failures that may impact user experiences. Such radio link failures may be caused by a handover procedure between cells in which the UE is traveling being attempted or initiated at a time that is undesirably late given the high rate of travel of the UE.

For example, a UE traveling in a high speed train may be connected to a first cell, but may be quickly moving away from the second cell and towards a second cell. The UE may send a handover request, which may be or be associated with a measurement report that may be used by another device (e.g., a network entity) to determine whether to send a handover command to the UE. When the UE transmits a handover request using conventional techniques (e.g., using conventional timing parameter values) while in a high-mobility scenario, the UE's connection with the first cell (e.g., as measured by a reference signal received power (RSRP)) may become excessively weak by the time the UE sends the measurement report, or at least by the time the first cell transmits a responsive handover command. For example, the UE may not receive a transmission (such as the responsive handover command, which may in some cases be sent as downlink control information (DCI)) from a base station associated with a handover procedure due to excessively degraded signal quality. As a result, conventional handover procedures (e.g., timing aspects thereof) may suffer from poor reliability when a UE is operating in a high-mobility scenario.

To reduce or eliminate radio link failures (e.g., handover failures) while operating in high-mobility (e.g., high-speed) scenarios or engaging in high mobility communications, a UE may use one or more techniques as described herein. For example, a UE may identify that the UE is in a high-mobility scenario. The UE may further identify that signal conditions support an early handover procedure (e.g., a first RSRP associated with a first cell is steadily decreasing, and a second RSRP associated with a second cell is steadily decreasing). Based on one or more of such conditions being satisfied, the UE may modify one or more values of parameters associated with the handover procedure between cells to reduce or eliminate delays in the handover procedure (e.g., a timeToTrigger parameter, an a3-offset parameter, or both). For example, to reduce or eliminate delays in requesting a handover, the UE may modify the timeToTrigger parameter to have a value of 0, or additionally or alternatively may modify the a3-offset parameter to have a value of 0. The UE may further transmit a handover request (e.g., a measurement report) at a time that is based on the one or more modified parameters or values, and thus may do so at a point in time sooner than the UE would with unmodified parameters or values (e.g., with parameters having the values as previously configured by the network, as opposed to as subsequently adjusted by the UE), thereby saving time and better assuring a successful handover between cells, despite the high-mobility or high-speed scenario.

Aspects of the disclosure are initially described in the context of wireless communications systems. Aspects of the disclosure are then illustrated by a system diagram, an example handover scenario, and a process flow. Aspects of the disclosure are further illustrated by and described with reference to apparatus diagrams, system diagrams, and flowcharts that relate to handover optimization for high mobility communications.

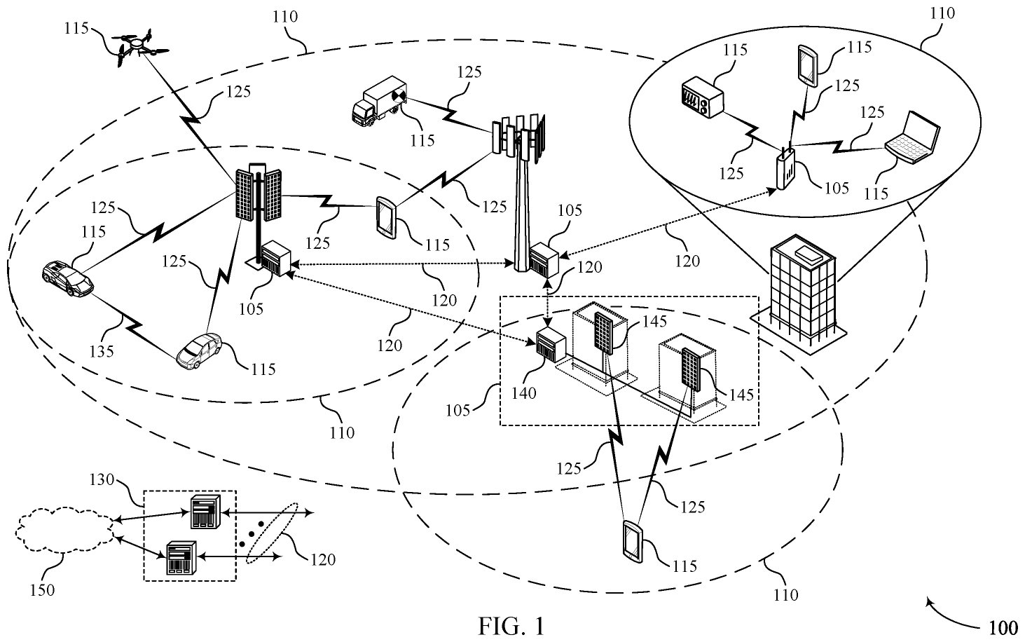

FIG. 1 illustrates an example of a wireless communications system 100 that supports handover optimization for high mobility communications in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some examples, the UE 115 may perform an improved handover procedure for use in high mobility scenarios. The UE 115 may identify that the UE 115 is operating in a high mobility environment or is engaging in high mobility communications. In such high mobility environments, the UE 115 may be travelling between different cells, and the UE 115 may further identify that an RSRP associated with a first cell is decreasing and an RSRP associated with a second cell may be increasing. Thus, the UE 115 may determine that the UE 115 may be operating in a scenario in which a handover may be performed, and that the handover may be performed more quickly (e.g., as compared to when operating in a non-high-mobility environment). As such, the UE 115 may adjust one or more values associated with one or more handover timing parameters to perform an accelerated handover procedure. The UE 115 may transmit a request for handover based on one or more of these handover timing parameters, and may do so at a time that may be based on one or more values that the UE 115 has modified (e.g., to perform an accelerated handover procedure for high mobility communications). The UE 115 may receive the handover command in response to transmitting the request for handover (e.g., the base station 105 that may be associated with the first cell may initiate or transmit a handover command to the UE 115 to perform the handover). The UE 115 may perform a handover from the first cell to the second cell. In this way, the UE 115 may perform a modified handover process that may reduce or eliminate radio link failures due to handover process delays by modifying one or more network-configured parameters or values.

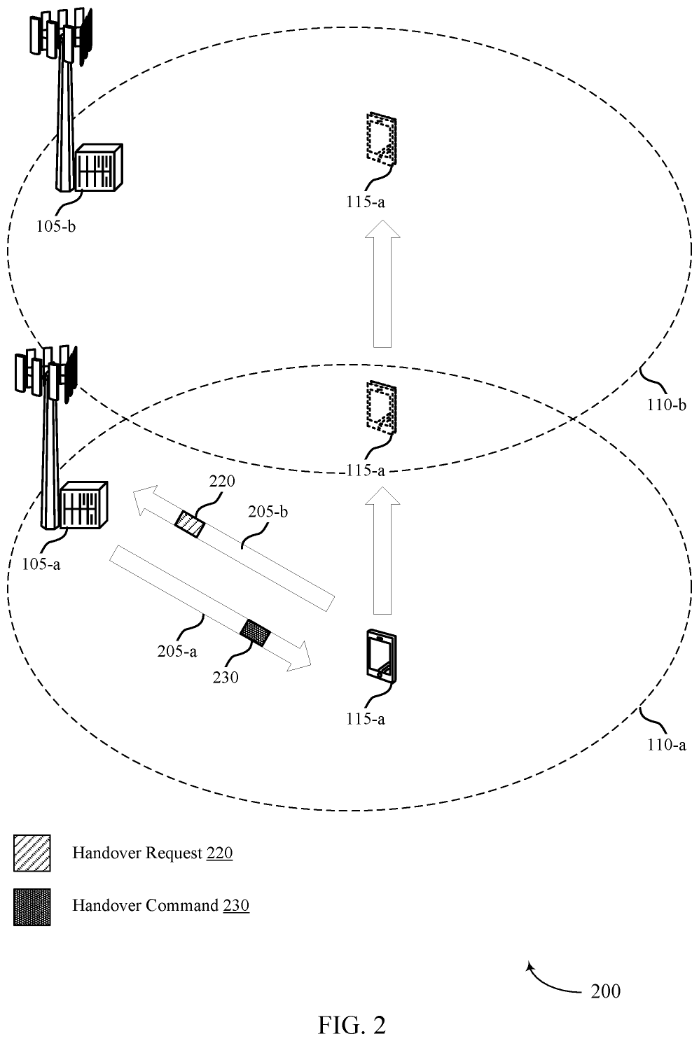

FIG. 2 illustrates an example of a system 200 that supports handover optimization for high mobility communications in accordance with aspects of the present disclosure. The wireless communications system 200 may include base stations 105-a and 105-b that may be examples of the base station 105 discussed in relation to FIG. 1. The wireless communications system 200 may include UE 115-a that may be an example of UE 115 discussed in relation to FIG. 1. In some examples, the base station 105-a may be located in or associated with a geographic coverage area 110-a, and the base station 105-b may be located in or associated with a geographic coverage area 110-b. Further, the base station 105-a may be associated with a first cell, and the base station 105-b may be associated with a second cell. The UE 115-a may communicate via one or more downlink communication links 205-a and one or more uplink communication links 205-b (e.g., with the base station 105-a, base station 105-b, or both.

In the course of communications, UE 115-a may operate in a high mobility scenario, or may engage in high mobility communications. The UE 115-a may travel between one or more cells (e.g., the first cell associated with the base station 105-a and the second cell associated with the base station 105-b) or one or more geographic coverage areas (e.g., coverage area 110-a and coverage area 110-b). For example, if a user of the UE 115-a is travelling on a high-speed train or in a motor vehicle, the UE 115-a may engage in high mobility communications.

In the course of high mobility communications, the UE may travel along a fixed or predictable path (e.g., a train on railroad tracks, or a motor vehicle on an interstate highway). In such a scenario, the relationship between a serving cell and a neighbor cell (e.g., a neighbor cell that may receive a handover of the UE 115-a and may begin to serve the UE 115-a) may be clearer. For example, a UE 115-a engaging in high mobility communications may determine, identify, select, receive, or otherwise obtain a handover sequence that may indicate one or more cells with which the UE 115-a may interact or perform one or more handovers in the course of high mobility communications. For example, the UE 115-a may determine, identify, select, receive, or otherwise obtain information indicating that the UE 115-a will travel through coverage areas 110-a and 110-b, and may communicate in a first cell associated with the base station 105-a and may further communicate in a second cell associated with the base station 105-b. Additionally or alternatively, the UE 115-a may determine, identify, select, receive, or otherwise obtain information indicating a sequence of cells that may lie along or may be associated with a travel path of the UE 115-a. In some examples, the UE 115-a may transmit a request for handover based on the sequence of cells. Further, the UE 115-a may determine a cell handover sequence based on the sequence of cells. For example, the UE 115-a may determine that the UE 115-a is to perform a handover sequence through the sequence of cells that lie along or are associated with the travel path of the UE 115-a. In some examples, the UE 115-a may transmit a request for handover based on the determined handover sequence.

In some examples, the UE 115-a may determine, identify, select, receive, or otherwise obtain information indicating that the UE 115-a is operating in a high mobility environment or is engaging in high mobility communications. For example, the UE 115-a may be operating on a train (e.g., a high-speed train), a motor vehicle, or in another scenario. The UE 115-a may use one or more factors to make this determination, identification, selection, or reception (e.g., via one or more sensors, location services, connection to wireless networks, connection to a local area network, or other factors). Additionally or alternatively, the UE 115-a may determine, identify, select, receive, or otherwise obtain information indicating that the UE 115-a has performed a number of handovers within an amount of time, has communicated within a number of cells or base stations within an amount of time, has performed a number of other procedures within an amount of time, or any combination thereof, which may be one or more factors that the UE 115-a may utilize to determine, identify, select, receive, or otherwise obtain information indicating that the UE 115-a is operating in a high mobility environment or is engaging in high mobility communications. Additionally or alternatively, the UE 115-a may store an indication of the high mobility environment (e.g., with a flag, bit, field, or other indication). Such an indication may be based on the identification of the high mobility environment or high mobility communications. Further, such an indication may be used by the UE 115-a (e.g., as a trigger) to implement one or more other operations or procedures as described herein.

In some examples, the UE 115-a may further identify that an RSRP associated with a first cell (e.g., associated with the base station 105-a and coverage area 110-a) is decreasing and an RSRP associated with a second cell (associated with the base station 105-b and coverage area 110-b) may be increasing. For example, and as shown in FIG. 2, the UE 115-a may be present in an area that may be served by multiple cells (or on or near a border between two cells) or base stations, or may be in or near multiple coverage areas (e.g., coverage area 110-a and coverage area 110-b). In such scenarios, the UE 115-a may determine, identify, select, receive, or otherwise obtain information about multiple cells, coverage areas, base stations, or other elements of a wireless communications system, and one such example may be that of a first RSRP decreasing and a second RSRP increasing.

In some examples, the UE 115-a may transmit a handover request 220 (e.g., to the base station 105-a). The handover request 220 may include one or more indications that may be used in a handover procedure or upon which a handover procedure may be based. For example, a handover request 220 may include information or indications, such as a serving cell RSRP, a neighbor cell RSRP, or a combination thereof (e.g., the RSRP that the UE 115-a may detect as decreasing, and the RSRP that the UE 115-a may detect as increasing). In some examples, the handover request 220 may include a measurement report, and the measurement report may include some or all of the same information or indications.

In some examples, the handover request 220 may be transmitted at a time that may be based on one or more handover timing parameters. The UE 115-a may modify one or more values associated with the one or more handover timing parameters. For example, the UE 115-a may modify a value of a timeToTrigger parameter (e.g., to 0). Additionally or alternatively, the UE 115-a may modify a value of an a3-offset parameter (e.g., to 0). In this way, the UE 115-a may transmit the handover request 220 at a time that may be different than a time at which the handover request 220 would be transmitted were the one or more values not modified. In some examples, the UE 115-a may transmit the handover request 220 more quickly, and this may result in a quicker handover procedure, thereby reducing or eliminating radio link failures in high mobility communications.

Additionally or alternatively, the UE 115-a may receive one or more indications of the one or more values to be modified (e.g., the UE 115-a may receive one or more timing values from a network entity). For example, the UE 115-a may receive a value for the timeToTrigger parameter, a value for the a3-offset parameter, or both. Subsequently, the UE 115-a may modify the parameters values based on the received values. For example, the UE 115-a may set one or more handover timing parameters to have one or more second values (e.g., values that may or may not be different from one or more initially configured values). In some examples, the UE 115-a may adjust the one or more values of the one or more handover timing parameters based on the UE setting the one or more handover timing parameters to have the one or more second values. Additionally or alternatively, the UE 115-a may detect that a first RSRP associated with a first cell or base station may be lower than or equal to a second RSRP associated with a second cell or base station. In some examples, the UE 115-a may transmit the handover request 220 based on the fact that the first RSRP associated with the first cell or base station may be lower than or equal to a second RSRP associated with the second cell or base station.

In some examples, the UE 115-a may receive a handover command 230 (e.g., from the base station 105-a). Such a handover command 230 may indicate that the UE 115-a is to begin communicating with a second cell or base station (e.g., base station 105-b). Additionally or alternatively, the handover command 230 may indicate information (e.g., configuration information) that the UE 115-a may utilize to begin communicating with the second cell or base station (e.g., base station 105-b). In some examples, the UE 115-a may receive the handover command 230 in response to transmitting the handover request 220. Additionally or alternatively, the UE 115-a may receive the handover command 230 in a DCI transmission. Additionally or alternatively, the handover command 230 may be signaled in a radio resource control (RRC) message, a medium access control control element (MAC-CE) message, one or more other message, or any combination thereof.

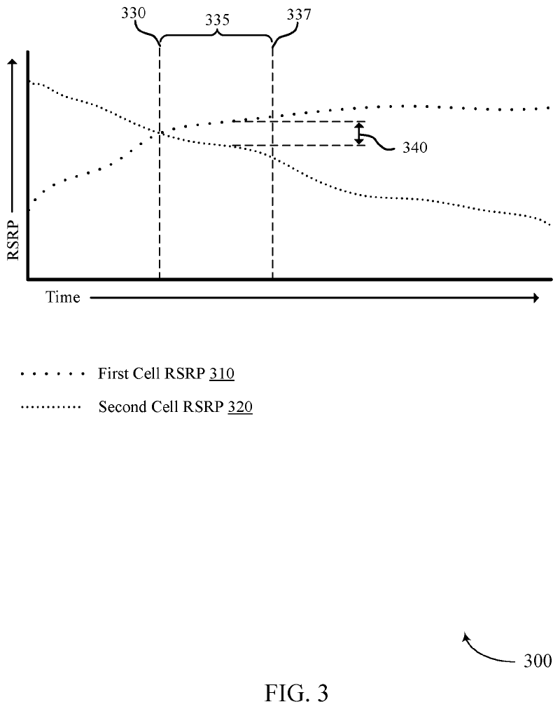

FIG. 3 illustrates an example of a handover scenario 300 that supports handover optimization for high mobility communications in accordance with aspects of the present disclosure. In the handover scenario 300, a UE may operate in a high mobility scenario or may engage in high mobility communications (e.g., as described herein). The UE may engage in a handover procedure in the high mobility scenario or while engaging in high mobility communications (e.g., as described herein).

In some such scenarios, the UE may determine, identify, select, receive, or otherwise obtain information indicating a first cell RSRP 310 and a second cell RSRP 320. In some examples, and as shown in FIG. 3, the first cell RSRP 310 may be decreasing over time and the second cell RSRP 320 may be increasing over time.

In some examples, the UE may be configured to transmit a handover request at or near the crossover point 330. The crossover point 330 may be a point in time at which the first cell RSRP 310 may be less than (alternatively, less than or equal to) the second cell RSRP 320. In some examples, the UE may transmit the request for handover at a handover request transmission point 337.

In some examples, and as discussed herein, the UE may modify one or more values associated with the one or more handover timing parameters. For example, the UE may modify a value of a timeToTrigger parameter (e.g., to 0). In some examples, a handover timing parameter or associated value may correspond to a delay between a first time and a second time. In some examples, the first time may be a time at which a difference between the second reference signal received power and the first reference signal received power satisfies a threshold. For example, the first time may be the crossover point 330. In some examples, the second time may be a time at which the request for handover is transmitted. For example, the second time may be the handover request transmission point 337. In an example in which a value associated with such a parameter is modified to 0, the UE may not include any delay in transmitting the handover request after determining, identifying, selecting, receiving, or otherwise obtaining information that the first cell RSRP 310, the second cell RSRP 320, or both, satisfy a condition (e.g., that the first cell RSRP 310 is less than or equal to the second cell RSRP 320).

Additionally or alternatively, the UE may modify a value of an a3-offset parameter (e.g., to 0). In some examples, a handover timing parameter or associated value may define an threshold difference 340 between the first cell RSRP 310 and the second cell RSRP 320. For example, the threshold difference 340 may define a difference in RSRP between the first cell RSRP 310 and the second cell RSRP 320 that may act as a trigger for performing a procedure or operation (e.g., preparing or transmitting a handover request). In some examples, the UE may monitor a measured difference in RSRP between the first cell RSRP 310 and the second cell RSRP 320, and if the difference satisfies a condition as compared to the defined difference (e.g., if the measured difference is greater than or equal to the defined difference (e.g., the threshold difference 340), the UE may transmit the handover request. In some examples, such a handover timing parameter or value may be adjusted to 0, which may indicate that the UE is to trigger the preparation or transmission of the handover request when the first cell RSRP 310 and the second cell RSRP 320 are the same, approximately the same, or comparable within a threshold.

In some examples, after performing a handover to a second cell, the UE may (e.g., due to the particular route of the UE during travel or the configuration or placement of base stations or other devices) enter a scenario in which one or more conditions (e.g., the first cell RSRP 310 and the second cell RSRP 320) may satisfy one or more conditions to perform a second handover procedure back to the first cell. However, such a handover back to a previously associated cell may not be desirable, or may cause one or more radio link failures. As such, the UE may further modify one or more handover timing parameters or values (e.g., the timeToTrigger parameter or associated value, the a3-offset parameter or associated value, or a third parameter or associated value) to decrease a likelihood that the UE initiates a handover procedure that would handover the UE back to a previously associated cell (e.g., within a time period or within a geographic area). For example, the UE may modify the threshold difference 340 to be biased or adjusted in favor of the second cell RSRP 320 (e.g., the first cell RSRP 310 may be an amount higher than the second cell RSRP 320 before another handover is performed or a handover request is prepared or transmitted, instead of the first cell RSRP 310 and the second cell RSRP 320 being approximately equal). In this way, the UE may avoid a “ping-pong” effect, in which the UE performs handovers back and forth between a number of cells, while still allowing for the possibility that the handover back to a previously associated cell may be appropriate (e.g., based upon a path of a train or a motor vehicle that may return to a previously associated coverage area or cell).

In some examples, the UE may transmit the handover request based on one or more of the modified handover timing parameters (e.g., the UE may transmit the handover request at a time that may be different than a time at which the UE would otherwise transmit the handover request were the handover timing parameters or values not modified). In some examples, the one or more handover timing parameters may be configured by a wireless communications network or a network entity. For example, the UE may receive the handover timing parameters from the network or a network entity, and may do so after the network or network entity configures them based on one or more network configuration factors.

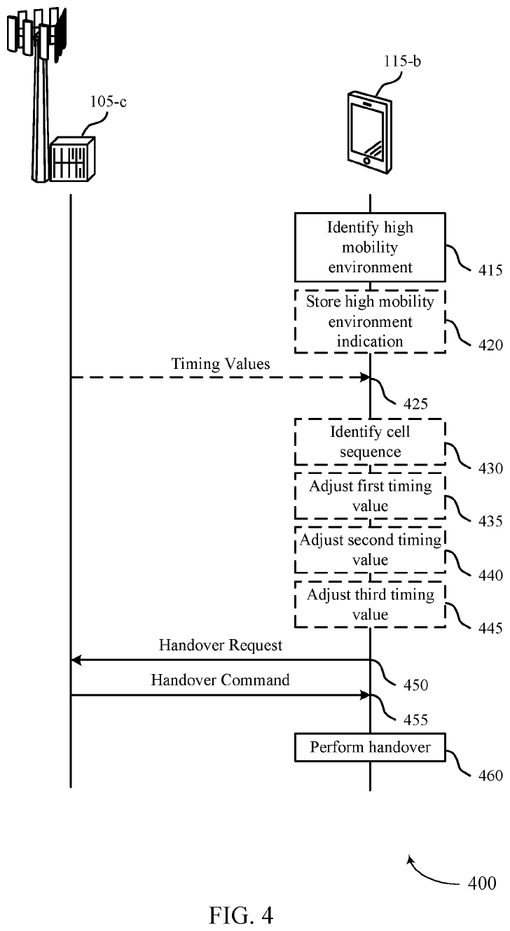

FIG. 4 illustrates an example of a process flow 400 that supports handover optimization for high mobility communications in accordance with aspects of the present disclosure. FIG. 4 illustrates an example of a process flow 400 that supports sidelink channel access timeline techniques for wireless communications systems in accordance with one or more aspects of the present disclosure. The process flow 400 may implement various aspects of the present disclosure described with reference to FIGS. 1-3. The process flow 400 may include a UE 115-b and a base station 105-c, which may be examples of UE 115 and base station 105 as described with reference to FIGS. 1-3. In some examples, the UE 115-b may be configured with a one or more parameters for handover procedures in high mobility communications.

In the following description of the process flow 400, the operations between the UE 115-b and the base station 105-c may be performed in different orders or at different times. Some operations may also be left out of the process flow 400, or other operations may be added. Although the UE 115-b and the base station 105-c are shown performing the operations of the process flow 400, some aspects of some operations may also be performed by the base station 105-b, the UE 115-c, one or more other wireless devices, or any combination thereof.

At 415, the UE 115-b may identify that the UE is operating in a high mobility environment, that a first reference signal received power associated with a first cell is decreasing, and that a second reference signal received power associated with a second cell is increasing. In some examples, the high mobility environment may be associated with a high-speed train. In some examples, the high mobility environment may be associated with a motor vehicle.

At 420, the UE 115-b may store, at the UE, an indication of the high mobility environment based at least in part on identifying that the UE is operating in the high mobility environment.

At 425, the UE 115-b may receive one or more first values of the one or more network-configured handover timing parameters from a network entity. The UE may further set, after receiving the one or more first values, the one or more network-configured handover timing parameters to have one or more second values, wherein the one or more network-configured handover timing parameters have the one or more values adjusted by the UE based at least in part on the UE setting the one or more network-configured handover timing parameters to have the one or more second values

At 430, the UE 115-b may identify a sequence of cells associated with a mobility path of the UE. Transmitting the request for the handover from the first cell to the second cell may be based at least in part on the second cell being subsequent to the first cell within the sequence of cells.

At 435, the UE 115-b may adjust a value of a first network-configured handover timing parameter of the one or more network-configured handover timing parameters. The first network-configured handover timing parameter may correspond to a delay between a first time at which a difference between the second reference signal received power and the first reference signal received power satisfies a threshold and a second time at which the request for handover is transmitted. In some examples, the adjusted value of the first network-configured handover timing parameter may be zero.

At 440, the UE 115-b may adjusting a value of a second network-configured handover timing parameter of the one or more network-configured handover timing parameters. The second network-configured handover timing parameter may correspond to a threshold difference between the second reference signal received power and the first reference signal received power. In some examples, the adjusted value of the second network-configured handover timing parameter may be zero

At 445, the UE 115-b may adjust a value of a third network-configured handover timing parameter of the one or more network-configured handover timing parameters after performing the handover. The adjusted value of the third network-configured handover timing parameter may decrease a likelihood of the UE initiating a second handover from the second cell to the first cell. In some cases, the UE 115-b may adjust a value of a third network-configured handover timing parameter after transmitting the handover request at 450, after receiving the handover command at 455, or after performing the handover at 460.

At 450, the UE 115-b may transmit a request for a handover from the first cell to the second cell based at least in part on the identifying. The transmitting may be performed at a time that is based at least in part on one or more network-configured handover timing parameters having one or more values adjusted by the UE. In some examples, the time at which the UE transmits the request for handover may be based at least in part on the adjusted value of the first network-configured handover timing parameter. In some examples, the time at which the UE transmits the request for handover may be based at least in part on a difference between the second reference signal received power and the first reference signal received power satisfying the adjusted value of the second network-configured handover timing parameter. In some examples, transmitting the request for the handover may be based at least in part on the first reference signal received power becoming less than or equal to the second reference signal received power. In some examples, transmitting the request for he handover may include transmitting a measurement report.

At 455, the UE 115-b may receive a handover command in response to transmitting the request for handover. In some examples, the UE 115-b may receive downlink control information that may include the handover command.

At 460, the UE 115-b may perform a handover from the first cell to the second cell in response to the handover command.

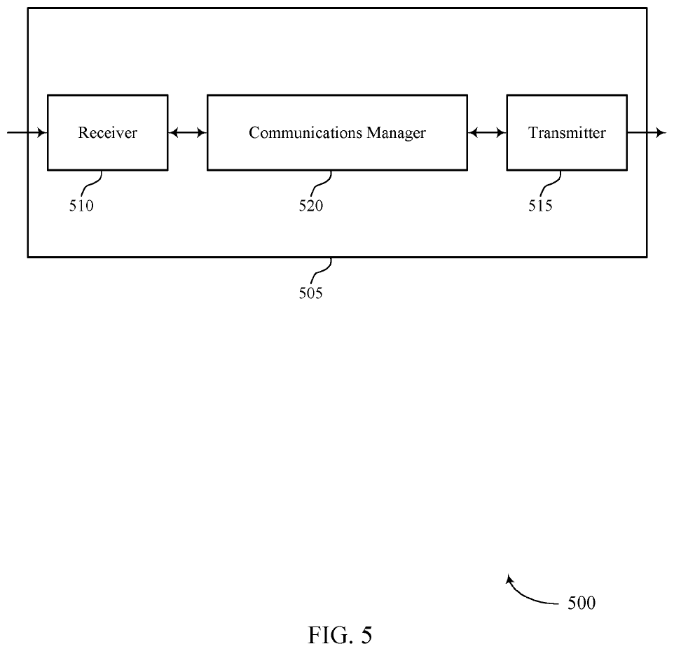

FIG. 5 shows a block diagram 500 of a device 505 that supports handover

optimization for high mobility scenario in accordance with aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to handover optimization for high mobility scenario). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to handover optimization for high mobility scenario). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of handover optimization for high mobility scenario as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communications at a UE in accordance with examples as disclosed herein. For example, the communications manager 520 may be configured as or otherwise support a means for identifying that the UE is operating in a high mobility environment, that a first reference signal received power associated with a first cell is decreasing, and that a second reference signal received power associated with a second cell is increasing. The communications manager 520 may be configured as or otherwise support a means for transmitting a request for a handover from the first cell to the second cell based on the identifying, the transmitting at a time that is based on one or more network-configured handover timing parameters having one or more values adjusted by the UE. The communications manager 520 may be configured as or otherwise support a means for receiving a handover command in response to transmitting the request for handover. The communications manager 520 may be configured as or otherwise support a means for performing a handover from the first cell to the second cell in response to the handover command.

By including or configuring the communications manager 520 in accordance with examples as described herein, the device 505 (e.g., a processor controlling or otherwise coupled to the receiver 510, the transmitter 515, the communications manager 520, or a combination thereof) may support techniques for [[***Add modem/processor level advantages (e.g., reduced processing, reduced power consumption, more efficient utilization of communication resources)***]]

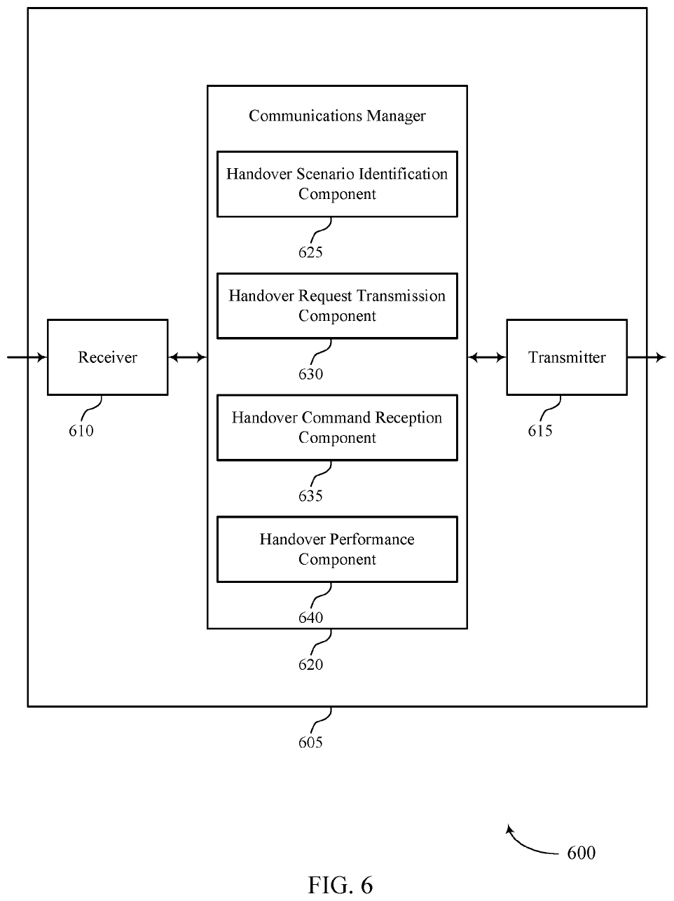

FIG. 6 shows a block diagram 600 of a device 605 that supports handover optimization for high mobility scenario in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to handover optimization for high mobility scenario). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to handover optimization for high mobility scenario). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of handover optimization for high mobility scenario as described herein. For example, the communications manager 620 may include a handover scenario identification component 625, a handover request transmission component 630, a handover command reception component 635, a handover performance component 640, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at a UE in accordance with examples as disclosed herein. The handover scenario identification component 625 may be configured as or otherwise support a means for identifying that the UE is operating in a high mobility environment, that a first reference signal received power associated with a first cell is decreasing, and that a second reference signal received power associated with a second cell is increasing. The handover request transmission component 630 may be configured as or otherwise support a means for transmitting a request for a handover from the first cell to the second cell based on the identifying, the transmitting at a time that is based on one or more network-configured handover timing parameters having one or more values adjusted by the UE. The handover command reception component 635 may be configured as or otherwise support a means for receiving a handover command in response to transmitting the request for handover. The handover performance component 640 may be configured as or otherwise support a means for performing a handover from the first cell to the second cell in response to the handover command.

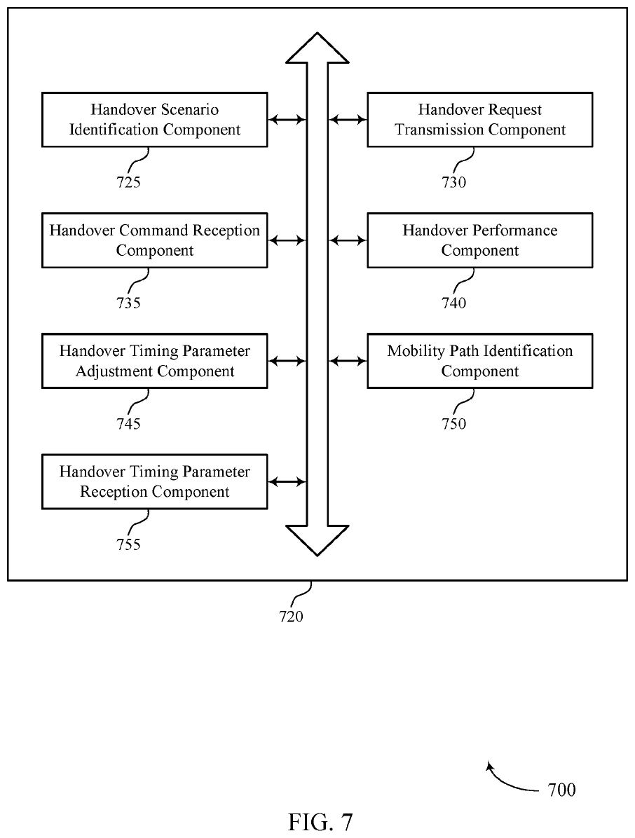

FIG. 7 shows a block diagram 700 of a communications manager 720 that supports handover optimization for high mobility scenario in accordance with aspects of the present disclosure. The communications manager 720 may be an example of aspects of a communications manager 520, a communications manager 620, or both, as described herein. The communications manager 720, or various components thereof, may be an example of means for performing various aspects of handover optimization for high mobility scenario as described herein. For example, the communications manager 720 may include a handover scenario identification component 725, a handover request transmission component 730, a handover command reception component 735, a handover performance component 740, a handover timing parameter adjustment component 745, a mobility path identification component 750, a handover timing parameter reception component 755, or any combination thereof. Each of these components may communicate, directly or indirectly, with one another (e.g., via one or more buses).

The communications manager 720 may support wireless communications at a UE in accordance with examples as disclosed herein. The handover scenario identification component 725 may be configured as or otherwise support a means for identifying that the UE is operating in a high mobility environment, that a first reference signal received power associated with a first cell is decreasing, and that a second reference signal received power associated with a second cell is increasing. The handover request transmission component 730 may be configured as or otherwise support a means for transmitting a request for a handover from the first cell to the second cell based on the identifying, the transmitting at a time that is based on one or more network-configured handover timing parameters having one or more values adjusted by the UE. The handover command reception component 735 may be configured as or otherwise support a means for receiving a handover command in response to transmitting the request for handover. The handover performance component 740 may be configured as or otherwise support a means for performing a handover from the first cell to the second cell in response to the handover command.

In some examples, the handover timing parameter adjustment component 745 may be configured as or otherwise support a means for adjusting a value of a first network-configured handover timing parameter of the one or more network-configured handover timing parameters, where the first network-configured handover timing parameter corresponds to a delay between a first time at which a difference between the second reference signal received power and the first reference signal received power satisfies a threshold and a second time at which the request for handover is transmitted and the time at which the UE transmits the request for handover is based on the adjusted value of the first network-configured handover timing parameter.

In some examples, the adjusted value of the first network-configured handover timing parameter is zero.

In some examples, the handover timing parameter adjustment component 745 may be configured as or otherwise support a means for adjusting a value of a second network-configured handover timing parameter of the one or more network-configured handover timing parameters, where: the second network-configured handover timing parameter corresponds to a threshold difference between the second reference signal received power and the first reference signal received power, and the time at which the UE transmits the request for handover is based on a difference between the second reference signal received power and the first reference signal received power satisfying the adjusted value of the second network-configured handover timing parameter.

In some examples, the adjusted value of the second network-configured handover timing parameter is zero.

In some examples, the handover timing parameter adjustment component 745 may be configured as or otherwise support a means for adjusting a value of a third network-configured handover timing parameter of the one or more network-configured handover timing parameters after performing the handover, where the adjusted value of the third network-configured handover timing parameter decreases a likelihood of the UE initiating a second handover from the second cell to the first cell.

In some examples, transmitting the request for the handover is based on the first reference signal received power becoming less than or equal to the second reference signal received power.

In some examples, to support transmitting the request for the handover, the handover request transmission component 730 may be configured as or otherwise support a means for transmitting a measurement report based at least in part on the first reference signal received power associated with the first cell, the second reference signal received power associated with the second cell, or any combination thereof.

In some examples, the mobility path identification component 750 may be configured as or otherwise support a means for identifying a sequence of cells associated with a mobility path of the UE, where transmitting the request for the handover from the first cell to the second cell is based on the second cell being subsequent to the first cell within the sequence of cells.

In some examples, to support receiving the handover command, the handover command reception component 735 may be configured as or otherwise support a means for receiving downlink control information that includes the handover command.

In some examples, the handover scenario identification component 725 may be configured as or otherwise support a means for storing, at the UE, an indication of the high mobility environment based on identifying that the UE is operating in the high mobility environment. In some examples, the high mobility environment is associated with a high-speed train. In some examples, the high mobility environment is associated with a motor vehicle.

In some examples, the handover timing parameter reception component 755 may be configured as or otherwise support a means for receiving one or more first values of the one or more network-configured handover timing parameters from a network entity. In some examples, the handover timing parameter adjustment component 745 may be configured as or otherwise support a means for setting, after receiving the one or more first values, the one or more network-configured handover timing parameters to have one or more second values, where the one or more network-configured handover timing parameters have the one or more values adjusted by the UE based on the UE setting the one or more network-configured handover timing parameters to have the one or more second values.

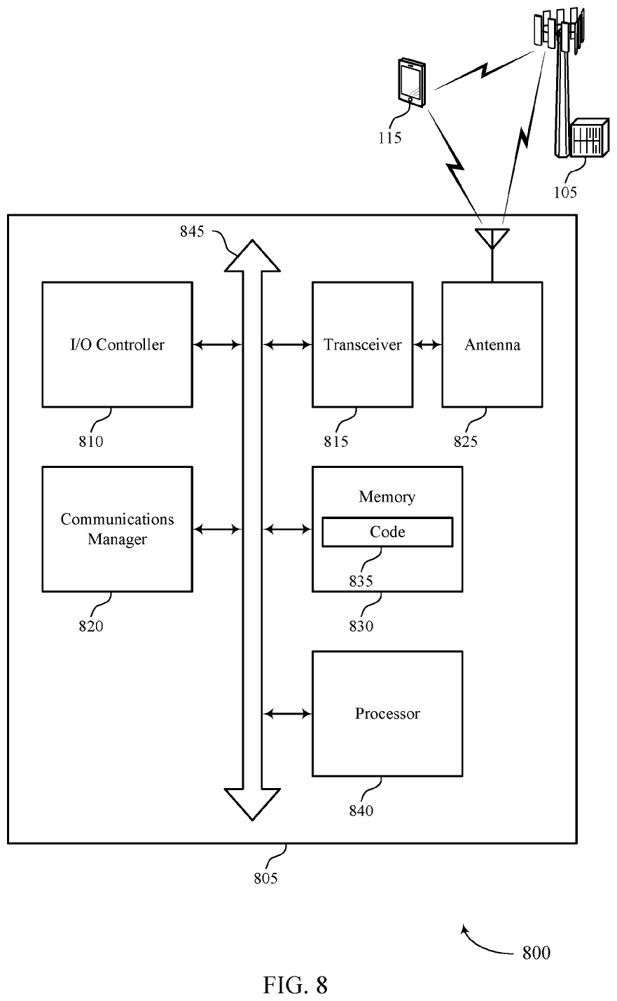

FIG. 8 shows a diagram of a system 800 including a device 805 that supports handover optimization for high mobility scenario in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting handover optimization for high mobility scenario). For example, the device 805 or a component of the device 805 may include a processor 840 and memory 830 coupled to the processor 840, the processor 840 and memory 830 configured to perform various functions described herein.

The communications manager 820 may support wireless communications at a UE in accordance with examples as disclosed herein. For example, the communications manager 820 may be configured as or otherwise support a means for identifying that the UE is operating in a high mobility environment, that a first reference signal received power associated with a first cell is decreasing, and that a second reference signal received power associated with a second cell is increasing. The communications manager 820 may be configured as or otherwise support a means for transmitting a request for a handover from the first cell to the second cell based on the identifying, the transmitting at a time that is based on one or more network-configured handover timing parameters having one or more values adjusted by the UE. The communications manager 820 may be configured as or otherwise support a means for receiving a handover command in response to transmitting the request for handover. The communications manager 820 may be configured as or otherwise support a means for performing a handover from the first cell to the second cell in response to the handover command.

By including or configuring the communications manager 820 in accordance with examples as described herein, the device 805 may support techniques for improved communication reliability, reduced latency, improved user experience related to reduced processing, reduced power consumption, more efficient utilization of communication resources, improved coordination between devices, longer battery life, improved utilization of processing capability, or a combination thereof.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of handover optimization for high mobility scenario as described herein, or the processor 840 and the memory 830 may be otherwise configured to perform or support such operations.

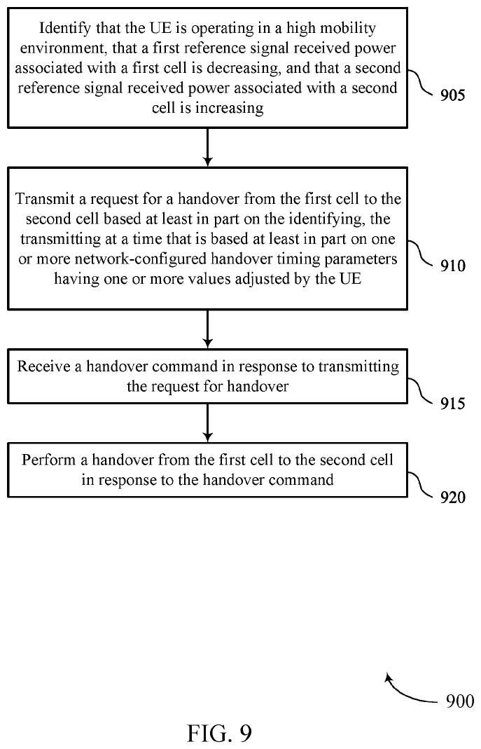

FIG. 9 shows a flowchart illustrating a method 900 that supports handover optimization for high mobility scenario in accordance with aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 905, the method may include identifying that the UE is operating in a high mobility environment, that a first reference signal received power associated with a first cell is decreasing, and that a second reference signal received power associated with a second cell is increasing. The operations of 905 may be performed in accordance with examples as disclosed herein. In some examples, aspects of the operations of 905 may be performed by a handover scenario identification component 725 as described with reference to FIG. 7. Additionally or alternatively, means for performing 905 may, but not necessarily, include, for example, antenna 825, transceiver 815, communications manager 820, memory 830 (including code 835), processor 840 and/or bus 845.

At 910, the method may include transmitting a request for a handover from the first cell to the second cell based on the identifying, the transmitting at a time that is based on one or more network-configured handover timing parameters having one or more values adjusted by the UE. The operations of 910 may be performed in accordance with examples as disclosed herein. In some examples, aspects of the operations of 910 may be performed by a handover request transmission component 730 as described with reference to FIG. 7. Additionally or alternatively, means for performing 910 may, but not necessarily, include, for example, antenna 825, transceiver 815, communications manager 820, memory 830 (including code 835), processor 840 and/or bus 845.

At 915, the method may include receiving a handover command in response to transmitting the request for handover. The operations of 915 may be performed in accordance with examples as disclosed herein. In some examples, aspects of the operations of 915 may be performed by a handover command reception component 735 as described with reference to FIG. 7. Additionally or alternatively, means for performing 915 may, but not necessarily, include, for example, antenna 825, transceiver 815, communications manager 820, memory 830 (including code 835), processor 840 and/or bus 845.

At 920, the method may include performing a handover from the first cell to the second cell in response to the handover command. The operations of 920 may be performed in accordance with examples as disclosed herein. In some examples, aspects of the operations of 920 may be performed by a handover performance component 740 as described with reference to FIG. 7. Additionally or alternatively, means for performing 920 may, but not necessarily, include, for example, antenna 825, transceiver 815, communications manager 820, memory 830 (including code 835), processor 840 and/or bus 845.

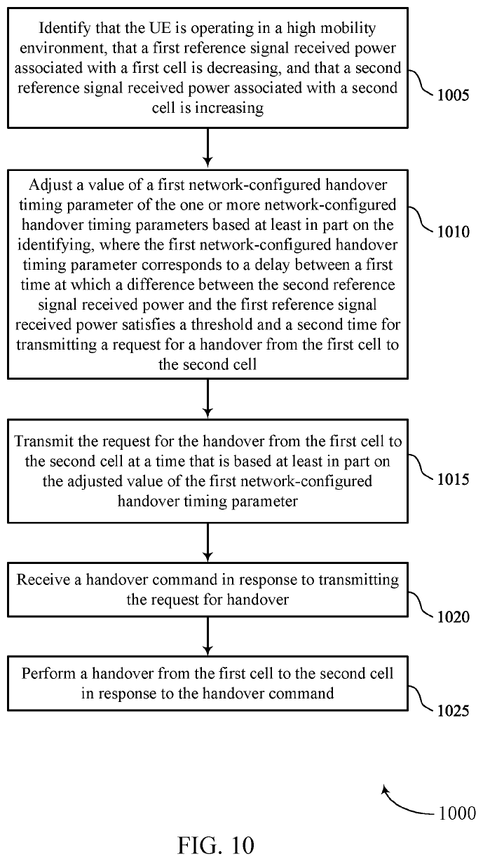

FIG. 10 shows a flowchart illustrating a method 1000 that supports handover optimization for high mobility scenario in accordance with aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1005, the method may include identifying that the UE is operating in a high mobility environment, that a first reference signal received power associated with a first cell is decreasing, and that a second reference signal received power associated with a second cell is increasing. The operations of 1005 may be performed in accordance with examples as disclosed herein. In some examples, aspects of the operations of 1005 may be performed by a handover scenario identification component 725 as described with reference to FIG. 7. Additionally or alternatively, means for performing 1005 may, but not necessarily, include, for example, antenna 825, transceiver 815, communications manager 820, memory 830 (including code 835), processor 840 and/or bus 845.

At 1010, the method may include adjusting a value of a first network-configured handover timing parameter of the one or more network-configured handover timing parameters based at least in part on the identifying, where the first network-configured handover timing parameter corresponds to a delay between a first time at which a difference between the second reference signal received power and the first reference signal received power satisfies a threshold and a second time for transmitting a request for a handover from the first cell to the second cell. The operations of 1010 may be performed in accordance with examples as disclosed herein. In some examples, aspects of the operations of 1010 may be performed by a handover timing parameter adjustment component 745 as described with reference to FIG. 7. Additionally or alternatively, means for performing 1010 may, but not necessarily, include, for example, antenna 825, transceiver 815, communications manager 820, memory 830 (including code 835), processor 840 and/or bus 845.

At 1015, the method may include transmitting the request for the handover from the first cell to the second cell at a time that is based on the adjusted value of the first network-configured handover timing parameter. The operations of 1015 may be performed in accordance with examples as disclosed herein. In some examples, aspects of the operations of 1015 may be performed by a handover request transmission component 730 as described with reference to FIG. 7. Additionally or alternatively, means for performing 1015 may, but not necessarily, include, for example, antenna 825, transceiver 815, communications manager 820, memory 830 (including code 835), processor 840 and/or bus 845.

At 1020, the method may include receiving a handover command in response to transmitting the request for handover. The operations of 1020 may be performed in accordance with examples as disclosed herein. In some examples, aspects of the operations of 1020 may be performed by a handover command reception component 735 as described with reference to FIG. 7. Additionally or alternatively, means for performing 1020 may, but not necessarily, include, for example, antenna 825, transceiver 815, communications manager 820, memory 830 (including code 835), processor 840 and/or bus 845.

At 1025, the method may include performing a handover from the first cell to the second cell in response to the handover command. The operations of 1025 may be performed in accordance with examples as disclosed herein. In some examples, aspects of the operations of 1025 may be performed by a handover performance component 740 as described with reference to FIG. 7. Additionally or alternatively, means for performing 1025 may, but not necessarily, include, for example, antenna 825, transceiver 815, communications manager 820, memory 830 (including code 835), processor 840 and/or bus 845.

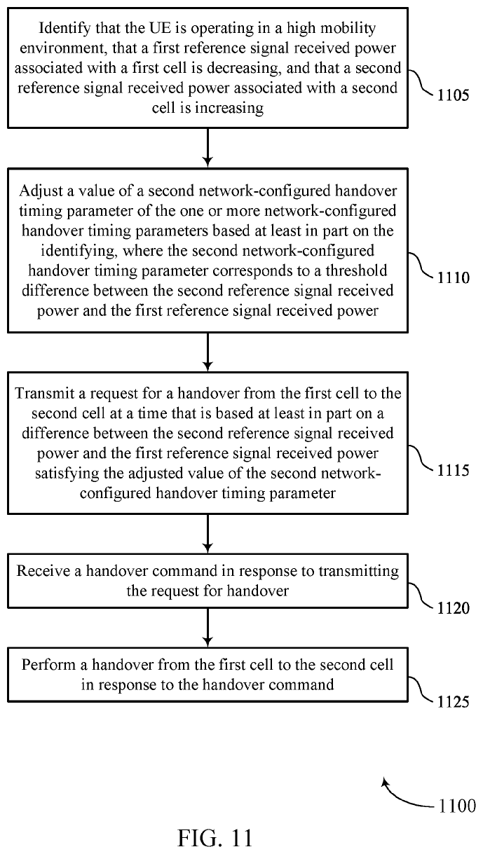

FIG. 11 shows a flowchart illustrating a method 1100 that supports handover optimization for high mobility scenario in accordance with aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1105, the method may include identifying that the UE is operating in a high mobility environment, that a first reference signal received power associated with a first cell is decreasing, and that a second reference signal received power associated with a second cell is increasing. The operations of 1105 may be performed in accordance with examples as disclosed herein. In some examples, aspects of the operations of 1105 may be performed by a handover scenario identification component 725 as described with reference to FIG. 7. Additionally or alternatively, means for performing 1105 may, but not necessarily, include, for example, antenna 825, transceiver 815, communications manager 820, memory 830 (including code 835), processor 840 and/or bus 845.

At 1110, the method may include adjusting a value of a second network-configured handover timing parameter of the one or more network-configured handover timing parameters based at least in part on the identifying, where the second network-configured handover timing parameter corresponds to a threshold difference between the second reference signal received power and the first reference signal received power. The operations of 1110 may be performed in accordance with examples as disclosed herein. In some examples, aspects of the operations of 1110 may be performed by a handover timing parameter adjustment component 745 as described with reference to FIG. 7. Additionally or alternatively, means for performing 1110 may, but not necessarily, include, for example, antenna 825, transceiver 815, communications manager 820, memory 830 (including code 835), processor 840 and/or bus 845.

At 1115, the method may include transmitting a request for a handover from the first cell to the second cell based at a time that is based on a difference between the second reference signal received power and the first reference signal received power satisfying the adjusted value of the second network-configured handover timing parameter. The operations of 1115 may be performed in accordance with examples as disclosed herein. In some examples, aspects of the operations of 1115 may be performed by a handover request transmission component 730 as described with reference to FIG. 7. Additionally or alternatively, means for performing 1115 may, but not necessarily, include, for example, antenna 825, transceiver 815, communications manager 820, memory 830 (including code 835), processor 840 and/or bus 845.

At 1120, the method may include receiving a handover command in response to transmitting the request for handover. The operations of 1120 may be performed in accordance with examples as disclosed herein. In some examples, aspects of the operations of 1120 may be performed by a handover command reception component 735 as described with reference to FIG. 7. Additionally or alternatively, means for performing 1120 may, but not necessarily, include, for example, antenna 825, transceiver 815, communications manager 820, memory 830 (including code 835), processor 840 and/or bus 845.

At 1125, the method may include performing a handover from the first cell to the second cell in response to the handover command. The operations of 1125 may be performed in accordance with examples as disclosed herein. In some examples, aspects of the operations of 1125 may be performed by a handover performance component 740 as described with reference to FIG. 7. Additionally or alternatively, means for performing 1125 may, but not necessarily, include, for example, antenna 825, transceiver 815, communications manager 820, memory 830 (including code 835), processor 840 and/or bus 845.

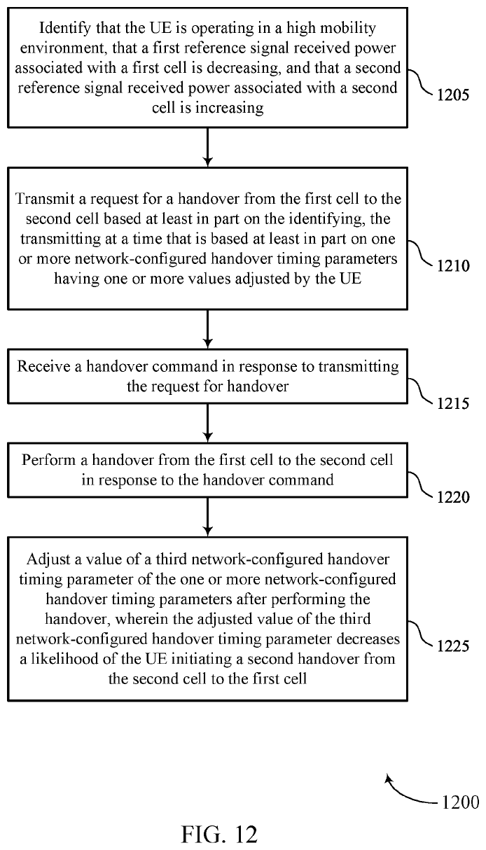

FIG. 12 shows a flowchart illustrating a method 1200 that supports handover optimization for high mobility scenario in accordance with aspects of the present disclosure. The operations of the method 1200 may be implemented by a UE or its components as described herein. For example, the operations of the method 1200 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1205, the method may include identifying that the UE is operating in a high mobility environment, that a first reference signal received power associated with a first cell is decreasing, and that a second reference signal received power associated with a second cell is increasing. The operations of 1205 may be performed in accordance with examples as disclosed herein. In some examples, aspects of the operations of 1205 may be performed by a handover scenario identification component 725 as described with reference to FIG. 7. Additionally or alternatively, means for performing 1205 may, but not necessarily, include, for example, antenna 825, transceiver 815, communications manager 820, memory 830 (including code 835), processor 840 and/or bus 845.

At 1210, the method may include transmitting a request for a handover from the first cell to the second cell based on the identifying, the transmitting at a time that is based on one or more network-configured handover timing parameters having one or more values adjusted by the UE. The operations of 1210 may be performed in accordance with examples as disclosed herein. In some examples, aspects of the operations of 1210 may be performed by a handover request transmission component 730 as described with reference to FIG. 7. Additionally or alternatively, means for performing 1210 may, but not necessarily, include, for example, antenna 825, transceiver 815, communications manager 820, memory 830 (including code 835), processor 840 and/or bus 845.

At 1215, the method may include receiving a handover command in response to transmitting the request for handover. The operations of 1215 may be performed in accordance with examples as disclosed herein. In some examples, aspects of the operations of 1215 may be performed by a handover command reception component 735 as described with reference to FIG. 7. Additionally or alternatively, means for performing 1215 may, but not necessarily, include, for example, antenna 825, transceiver 815, communications manager 820, memory 830 (including code 835), processor 840 and/or bus 845.

At 1220, the method may include performing a handover from the first cell to the second cell in response to the handover command. The operations of 1220 may be performed in accordance with examples as disclosed herein. In some examples, aspects of the operations of 1220 may be performed by a handover performance component 740 as described with reference to FIG. 7. Additionally or alternatively, means for performing 1220 may, but not necessarily, include, for example, antenna 825, transceiver 815, communications manager 820, memory 830 (including code 835), processor 840 and/or bus 845.

At 1225, the method may include adjusting a value of a third network-configured handover timing parameter of the one or more network-configured handover timing parameters after performing the handover, where the adjusted value of the third network-configured handover timing parameter decreases a likelihood of the UE initiating a second handover from the second cell to the first cell. The operations of 1225 may be performed in accordance with examples as disclosed herein. In some examples, aspects of the operations of 1225 may be performed by a handover timing parameter adjustment component 745 as described with reference to FIG. 7. Additionally or alternatively, means for performing 1225 may, but not necessarily, include, for example, antenna 825, transceiver 815, communications manager 820, memory 830 (including code 835), processor 840 and/or bus 845.

The following provides an overview of aspects of the present disclosure:

Aspect 1: A method for wireless communications at a UE, comprising: identifying that the UE is operating in a high mobility environment, that a first reference signal received power associated with a first cell is decreasing, and that a second reference signal received power associated with a second cell is increasing; transmitting a request for a handover from the first cell to the second cell based at least in part on the identifying, the transmitting performed at a time that is based at least in part on one or more network-configured handover timing parameters having one or more values adjusted by the UE; receiving a handover command in response to transmitting the request for handover; and performing a handover from the first cell to the second cell in response to the handover command.

Aspect 2: The method of aspect 1, further comprising: adjusting a value of a first network-configured handover timing parameter of the one or more network-configured handover timing parameters, wherein: the first network-configured handover timing parameter corresponds to a delay between a first time at which a difference between the second reference signal received power and the first reference signal received power satisfies a threshold and a second time at which the request for handover is transmitted; and the time at which the UE transmits the request for handover is based at least in part on the adjusted value of the first network-configured handover timing parameter.

Aspect 3: The method of aspect 2, wherein the adjusted value of the first network-configured handover timing parameter is zero.

Aspect 4: The method of any of aspects 1 through 3, further comprising: adjusting a value of a second network-configured handover timing parameter of the one or more network-configured handover timing parameters, wherein: the second network-configured handover timing parameter corresponds to a threshold difference between the second reference signal received power and the first reference signal received power, and the time at which the UE transmits the request for handover is based at least in part on a difference between the second reference signal received power and the first reference signal received power satisfying the adjusted value of the second network-configured handover timing parameter.

Aspect 5: The method of aspect 4, wherein the adjusted value of the second network-configured handover timing parameter is zero.

Aspect 6: The method of any of aspects 1 through 5, further comprising: adjusting a value of a third network-configured handover timing parameter of the one or more network-configured handover timing parameters after performing the handover, wherein the adjusted value of the third network-configured handover timing parameter decreases a likelihood of the UE initiating a second handover from the second cell to the first cell.

Aspect 7: The method of any of aspects 1 through 6, wherein transmitting the request for the handover is based at least in part on the first reference signal received power becoming less than or equal to the second reference signal received power.

Aspect 8: The method of any of aspects 1 through 7, wherein transmitting the request for the handover comprises transmitting a measurement report based at least in part on the first reference signal received power associated with the first cell, the second reference signal received power associated with the second cell, or any combination thereof.

Aspect 9: The method of any of aspects 1 through 8, further comprising: identifying a sequence of cells associated with a mobility path of the UE, wherein transmitting the request for the handover from the first cell to the second cell is based at least in part on the second cell being subsequent to the first cell within the sequence of cells.

Aspect 10: The method of any of aspects 1 through 9, wherein receiving the handover command comprises receiving downlink control information that comprises the handover command.

Aspect 11: The method of any of aspects 1 through 10, further comprising: storing, at the UE, an indication of the high mobility environment based at least in part on identifying that the UE is operating in the high mobility environment.

Aspect 12: The method of any of aspects 1 through 11, wherein the high mobility environment is associated with a high-speed train.

Aspect 13: The method of any of aspects 1 through 12, wherein the high mobility environment is associated with a motor vehicle.

Aspect 14: The method of any of aspects 1 through 13, further comprising: receiving one or more first values of the one or more network-configured handover timing parameters from a network entity; and setting, after receiving the one or more first values, the one or more network-configured handover timing parameters to have one or more second values, wherein the one or more network-configured handover timing parameters have the one or more values adjusted by the UE based at least in part on the UE setting the one or more network-configured handover timing parameters to have the one or more second values.

Aspect 15: An apparatus comprising a processor; a transceiver coupled with the processor; and memory coupled with the processor, the memory and the processor configured to cause the apparatus to perform a method of any of aspects 1 through 14.

Aspect 16: An apparatus for wireless communications at a UE, comprising at least one means for performing a method of any of aspects 1 through 14.

Aspect 17: A non-transitory computer-readable medium storing code for wireless communications at a UE, the code comprising instructions executable by a processor to perform a method of any of aspects 1 through 14.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
identifying that the UE is operating in a high mobility environment, that a first reference signal received power associated with a first cell is decreasing, and that a second reference signal received power associated with a second cell is increasing;
transmitting a request for a handover from the first cell to the second cell based at least in part on the identifying, the transmitting performed at a time that is based at least in part on one or more network-configured handover timing parameters having one or more values adjusted by the UE;
receiving a handover command in response to transmitting the request for handover; and
performing a handover from the first cell to the second cell in response to the handover command.

2. The method of claim 1, further comprising:
adjusting a value of a first network-configured handover timing parameter of the one or more network-configured handover timing parameters, wherein:
the first network-configured handover timing parameter corresponds to a delay between a first time at which a difference between the second reference signal received power and the first reference signal received power satisfies a threshold and a second time at which the request for handover is transmitted; and
the time at which the UE transmits the request for handover is based at least in part on the adjusted value of the first network-configured handover timing parameter.

3. The method of claim 2, wherein the adjusted value of the first network-configured handover timing parameter is zero.

4. The method of claim 1, further comprising:
adjusting a value of a second network-configured handover timing parameter of the one or more network-configured handover timing parameters, wherein:
the second network-configured handover timing parameter corresponds to a threshold difference between the second reference signal received power and the first reference signal received power; and
the time at which the UE transmits the request for handover is based at least in part on a difference between the second reference signal received power and the first reference signal received power satisfying the adjusted value of the second network-configured handover timing parameter.

5. The method of claim 4, wherein the adjusted value of the second network-configured handover timing parameter is zero.

6. The method of claim 1, further comprising:
adjusting a value of a third network-configured handover timing parameter of the one or more network-configured handover timing parameters after performing the handover, wherein the adjusted value of the third network-configured handover timing parameter decreases a likelihood of the UE initiating a second handover from the second cell to the first cell.

7. The method of claim 1, wherein transmitting the request for the handover is based at least in part on the first reference signal received power becoming less than or equal to the second reference signal received power.

8. The method of claim 1, wherein transmitting the request for the handover comprises transmitting a measurement report based at least in part on the first reference signal received power associated with the first cell, the second reference signal received power associated with the second cell, or any combination thereof.

9. The method of claim 1, further comprising:
identifying a sequence of cells associated with a mobility path of the UE, wherein transmitting the request for the handover from the first cell to the second cell is based at least in part on the second cell being subsequent to the first cell within the sequence of cells.

10. The method of claim 1, wherein receiving the handover command comprises receiving downlink control information that comprises the handover command.

11. The method of claim 1, further comprising:
storing, at the UE, an indication of the high mobility environment based at least in part on identifying that the UE is operating in the high mobility environment.

12. The method of claim 1, wherein the high mobility environment is associated with a high-speed train.

13. The method of claim 1, wherein the high mobility environment is associated with a motor vehicle.

14. The method of claim 1, further comprising:
receiving one or more first values of the one or more network-configured handover timing parameters from a network entity; and
setting, after receiving the one or more first values, the one or more network-configured handover timing parameters to have one or more second values, wherein the one or more network-configured handover timing parameters have the one or more values adjusted by the UE based at least in part on the UE setting the one or more network-configured handover timing parameters to have the one or more second values.

15. An apparatus for wireless communications, comprising:
a processor of a user equipment (UE);
a transceiver coupled with the processor; and
memory coupled with the processor, the memory and the processor configured to cause the apparatus to:
identify that the UE is operating in a high mobility environment, that a first reference signal received power associated with a first cell is decreasing, and that a second reference signal received power associated with a second cell is increasing;
transmit, via the transceiver, a request for a handover from the first cell to the second cell based at least in part on the identifying, the transmitting performed at a time that is based at least in part on one or more network-configured handover timing parameters having one or more values adjusted by the UE;
receive, via the transceiver, a handover command in response to transmitting the request for handover; and
perform a handover from the first cell to the second cell in response to the handover command.

16. The apparatus of claim 15, the memory and the processor further configured to cause the apparatus to:
adjust a value of a first network-configured handover timing parameter of the one or more network-configured handover timing parameters, wherein:
the first network-configured handover timing parameter corresponds to a delay between a first time at which a difference between the second reference signal received power and the first reference signal received power satisfies a threshold and a second time at which the request for handover is transmitted; and
the time at which the UE transmits the request for handover is based at least in part on the adjusted value of the first network-configured handover timing parameter.

17. The apparatus of claim 16, wherein the adjusted value of the first network-configured handover timing parameter is zero.

18. The apparatus of claim 15, the memory and the processor further configured to cause the apparatus to:
adjust a value of a second network-configured handover timing parameter of the one or more network-configured handover timing parameters, wherein:
the second network-configured handover timing parameter corresponds to a threshold difference between the second reference signal received power and the first reference signal received power; and
the time at which the UE transmits the request for handover is based at least in part on a difference between the second reference signal received power and the first reference signal received power satisfying the adjusted value of the second 10 network-configured handover timing parameter.

19. The apparatus of claim 18, wherein the adjusted value of the second network-configured handover timing parameter is zero.

20. The apparatus of claim 15, the memory and the processor further configured to cause the apparatus to:
adjust a value of a third network-configured handover timing parameter of the one or more network-configured handover timing parameters after performing the handover, wherein the adjusted value of the third network-configured handover timing parameter decreases a likelihood of the UE initiating a second handover from the second cell to the first cell.

21. The apparatus of claim 15, the memory and the processor configured to cause the apparatus to transmit the request for the handover based at least in part on the first reference signal received power becoming less than or equal to the second reference signal received power.

22. The apparatus of claim 15, wherein, to transmit the request for the handover, the memory and the processor are configured to cause the apparatus to transmit, via the transceiver, a measurement report based at least in part on the first reference signal received power associated with the first cell, the second reference signal received power associated with the second cell, or any combination thereof.

23. The apparatus of claim 15, the memory and the processor further configured to cause the apparatus to:
identify a sequence of cells associated with a mobility path of the UE, wherein transmitting the request for the handover from the first cell to the second cell is based at least in part on the second cell being subsequent to the first cell within the sequence of cells.

24. The apparatus of claim 15, wherein, to receive the handover command, the memory and the processor are configured to cause the apparatus to:
receive, via the transceiver, downlink control information that comprises the handover command.

25. The apparatus of claim 15, the memory and the processor further configured to cause the apparatus to:
store, at the UE, an indication of the high mobility environment based at least in part on identifying that the UE is operating in the high mobility environment.

26. The apparatus of claim 15, wherein the high mobility environment is associated with a high-speed train.

27. The apparatus of claim 15, wherein the high mobility environment is associated with a motor vehicle.

28. The apparatus of claim 15, the memory and the processor further configured to cause the apparatus to:
receive, via the transceiver, one or more first values of the one or more network-configured handover timing parameters from a network entity; and
set, after receiving the one or more first values, the one or more network-configured handover timing parameters to have one or more second values, wherein the one or more network-configured handover timing parameters have the one or more values adjusted by the UE based at least in part on the UE setting the one or more network-configured handover timing parameters to have the one or more second values.

29. An apparatus for wireless communications at a user equipment (UE), comprising:
means for identifying that the UE is operating in a high mobility environment, that a first reference signal received power associated with a first cell is decreasing, and that a second reference signal received power associated with a second cell is increasing;
means for transmitting a request for a handover from the first cell to the second cell based at least in part on the identifying, the transmitting performed at a time that is based at least in part on one or more network-configured handover timing parameters having one or more values adjusted by the UE;
means for receiving a handover command in response to transmitting the request for handover; and
means for performing a handover from the first cell to the second cell in response to the handover command.

30. A non-transitory computer-readable medium storing code for wireless communications at a user equipment (UE), the code comprising instructions executable by a processor to:
identify that the UE is operating in a high mobility environment, that a first reference signal received power associated with a first cell is decreasing, and that a second reference signal received power associated with a second cell is increasing;
transmit a request for a handover from the first cell to the second cell based at least in part on the identifying, the transmitting performed at a time that is based at least in part on one or more network-configured handover timing parameters having one or more values adjusted by the UE;
receive a handover command in response to transmitting the request for handover, and
perform a handover from the first cell to the second cell in response to the handover command.
